(19) United States
(12) Patent Application Publication
(10) Pub. No.: US 2024/0291683 A1
(43) Pub. Date: Aug. 29, 2024

(54) INFORMATION INTERACTION METHOD AND APPARATUS, AND ELECTRONIC DEVICE

(71) Applicant: Beijing Zitiao Network Technology Co.,Ltd., Beijing (CN)

(72) Inventors: Liyue ZHAO, Beijing (CN); Yuanye WU, Beijing (CN); Bowen SHEN, Beijing (CN); Yunwei LIU, Beijing (CN)

(21) Appl. No.: 18/571,871

(22) PCT Filed: Aug. 3, 2022
(86) PCT No.: PCT/CN2022/109980

§ 371 Date: Dec. 19, 2023

(30) Foreign Application Priority Data
Aug. 6, 2021 (CN) 202110905604.0

(51) Int. Cl. H04L 12/18

(52) U.S. Cl. CPC H04L 12/185; H04L 12/1813

(57) ABSTRACT

Disclosed in embodiments of this disclosure are an information interaction method and apparatus, and an electronic device. One specific embodiment of the method includes: determining at least one target group in response to a preset team creation operation, where the at least one target group is a group that has been created before the team creation operation; and creating a team by determining a team member set based on members included in the at least one target group, where the team is associated with at least one information interaction tool, and information in the at least one information interaction tool is acquirable by at least a part of members in the team member set.

### CROSS-REFERENCE TO RELATED APPLICATION(S)

This disclosure claims priority to Chinese Patent Application No. 202110905604.0, filed on Aug. 6, 2021 and entitled “Information interaction method and apparatus, and electronic device”, which is incorporated in its entirety herein by reference.

### FIELD

This disclosure relates to the technical field of Internet, and in particular to an information interaction method and apparatus, and an electronic device.

### BACKGROUND

As the Internet develops, the user increasingly employ terminal devices to realize various functions. For example, users may interact with other users through instant messaging software in the terminal devices. The interaction mode between users may be one-to-one individual conversation interaction or multi-user intra-group conversation interaction.

### SUMMARY

The summary of this disclosure is provided to introduce concepts in a simplified form, and these concepts are described in detail in detailed description of embodiments below. The summary of this disclosure is neither intended to identify key features or essential features of claimed technical solutions, nor intended to limit the scope of the claimed technical solutions.

In a first aspect, an information interaction method is provided in an embodiment of this disclosure. The method includes: determining at least one target group in response to a preset team creation operation, where the at least one target group is a group that has been created before the team creation operation: and creating a team by determining a team member set based on members included in the at least one target group, where the team is associated with at least one information interaction tool, and information in the at least one information interaction tool is acquirable by at least a part of members in the team member set.

In a second aspect, an information interaction apparatus is provided in an embodiment of this disclosure. The apparatus includes: a determination unit configured to determine at least one target group in response to a preset team creation operation, where the at least one target group is a group that has been created before the team creation operation: and a creation unit configured to create a team by determining a team member set based on members included in the at least one target group, where the team is associated with at least one information interaction tool, and information in the at least one information interaction tool is acquirable by at least a part of members in the team member set.

In a third aspect, an electronic device is provided in an embodiment of this disclosure. The electronic device includes: one or more processors: and a storage means configured to store one or more programs, the one or more programs, when executed by the one or more processors, causing the one or more processors to implement the information interaction method in the first aspect.

In a fourth aspect, a computer-readable medium is provided in an embodiment of this disclosure. The computer-readable medium stores a computer program, where the computer program, when executed by a processor, implements the information interaction method in the first aspect.

### BRIEF DESCRIPTION OF THE DRAWINGS

The above and other features, advantages, and aspects in each embodiment of this disclosure will become more apparent with reference to the accompanying drawings and the following particular embodiments. The same or similar reference numerals denote the same or similar elements throughout the accompanying drawings. It should be understood that the accompanying drawings are illustrative, and devices and elements are not necessarily drawn to scale.

FIG. 1 is a flowchart of an embodiment of an information interaction method according to this disclosure:

FIG. 2 is a schematic diagram of an application scenario of an information interaction method according to this disclosure:

FIG. 3 is a schematic diagram of an application scenario of an information interaction method according to this disclosure:

FIG. 4 is a schematic structural diagram of an embodiment of an information interaction apparatus according to this disclosure:

FIG. 5 is an illustrative system architecture to which an information interaction method may be applied according to an embodiment of this disclosure: and

FIG. 6 is a schematic diagram of a basic structure of an electronic device according to an embodiment of this disclosure.

### DETAILED DESCRIPTION OF EMBODIMENTS

Embodiments of this disclosure will be further described in detail below in conjunction with the accompanying drawings. Although some embodiments of this disclosure are shown in the accompanying drawings, it should be understood that this disclosure can be implemented in various forms and should not be interpreted as being limited to the embodiments set forth herein. On the contrary, these embodiments are provided for a more thorough and complete understanding of this disclosure. It should be understood that the accompanying drawings and the embodiments of this disclosure are merely illustrative, and are not intended to limit the scope of protection of this disclosure.

It should be understood that various steps described in a method embodiment of this disclosure can be executed in different orders and/or in parallel. In addition, the method embodiment can include additional steps and/or will not execute the steps shown. The scope of this disclosure is not limited in this respect.

As used herein, the terms “comprise”, “include”, and their variations are open-ended, i.e. “comprise, but is not limited to” and “include, but is not limited to”. The term “based on” means “at least partially based on”. The term “an embodiment” means “at least one embodiment”. The term “another embodiment” means “at least one further embodiment”. The term “some embodiments” means “at least some embodiments”. The definitions relevant to other terms are set forth in the description below:

It should be noted that the concepts such as “first” and “second” mentioned in this disclosure are merely used to distinguish between different apparatuses, modules, or units instead of defining the order or interdependence relation of functions executed by these apparatuses, modules, or units.

It should be noted that the modifiers “a”, “an”, and “a plurality of” mentioned in this disclosure are illustrative rather than restrictive. Those skilled in the art should understand that these modifiers should be interpreted as “one or more” unless clearly indicated otherwise in the context.

The names of messages or information interacting between a plurality of apparatuses in the embodiments of this disclosure are merely descriptive, and are not intended to limit the scopes of these messages or information.

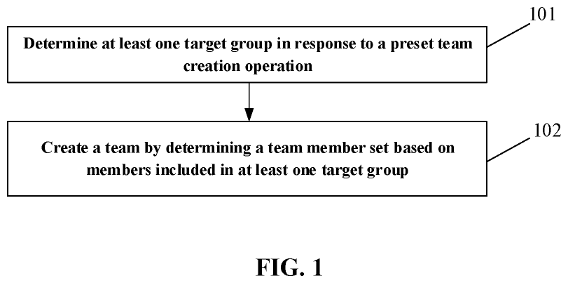

With reference to FIG. 1, a flow of an embodiment of an information interaction method according to this disclosure is shown in FIG. 1. The information interaction method is applied to a terminal device. As shown in FIG. 1, the information interaction method includes the following:

Step 101, at least one target group is determined in response to a preset team creation operation.

In the embodiment, an execution body (for example, a terminal device or a client mounted on the terminal device, such as an instant messaging (IM) client) of the information interaction method may determine at least one target group in response to the preset team creation operation.

The at least one target group is a group that has been created before the team creation operation herein.

In some application scenarios, the group may be understood as a group conversation. A plurality of users may send messages, etc. in the group conversation. For example, the group may be a group in an instant messaging tool.

A specific operation mode of the above preset team creation operation may be set according to an actual application scenario, which will not be limited herein.

As an example, the above team creation operation may include an operation of clicking a preset team creation control.

Step 102, a team is created by determining a team member set based on members included in at least one target group.

Herein, the team is associated with at least one information interaction tool, and information in the at least one information interaction tool is acquirable by at least a part of members in the team member set.

In some embodiments, the information interaction tool includes the group.

The members included in at least one target group may be in various relations with the team member set. For example, the team member set may be the same as the members included in at least one target group. For another example, the above team member set may be a sub-set of the members included in at least one target group.

Alternatively, if the above team member set is the sub-set of the members included in at least one target group, those users who are members of the target group instead of members of the team may be screened out through various preset rules. As an example, after at least one target group is determined, a member identifier of the target group may be displayed to the user currently logged in. Then, the user currently logged in may select a member to be screened out. Finally, members other than the members to be screened out among members of the target group may be determined as the team member set.

It should be noted that according to the information interaction method shown in the embodiment, at least one target group may be determined in response to the preset team creation operation, where the target group is the group that has been created before the team creation operation. Then, the team is created by determining the team member set based on the members included in at least one target group. Therefore, a new team creation way may be provided.

In some embodiments, a fixed group of contacts are delineated as a team member set at first to create the team in an instant messaging (IM) system. The team is perceived by users in a form of a team identifier on an IM interface. There is at least one group associated based on the team member set under the team. The group is a carrier for carrying information interaction of a plurality of people in the instant messaging system herein.

It should be noted that this new team creation way can increase a team creation speed. Specifically, in an interaction mode according to the embodiment, the team is created based on the group that has been created. Accordingly, the time for the user to select the team member is shortened, so that the team creation speed is increased.

In some embodiments, the information interaction tool may includes the group.

In some embodiment, the method further includes: the at least one target group is associated with the created team.

The expression that after the team is created, the target group is associated with the team herein may be interpreted in a way that the member of the target group becomes a group under the team, and a group under the team may be referred to as a team group.

In some application scenarios, the team group may also be presented on a team present page.

It should be noted that after the team is created based on the target group, an association relation between the target group and the team is constructed. Accordingly, the information interaction tool (for example, a group chat) may be automatically created for the team, a step for the user to create the information interaction tool (for example, the group chat) for the team additionally may be omitted, and thus an operation efficiency for the team can be improved.

In some embodiments, the method further includes: determining, in response to determining that one target group determined is provided, the target group as a first type of group associated with the team.

Herein, a member of the first type of group is kept consistent with a member of the team.

In some alternative embodiments, the first type of group is incapable of being disbanded, and an association relation between the first type of group and the team is incapable of being dismissed in the presence of the team. For example, either a disband control or a control for dismissing the association relation between the first type of group and the team is provided.

In some application scenarios, the first type of group may be configured to present a team notification. The first type of group may be interpreted as a default communication group in the presence of the team. The default communication group is required to present a team-level notification for the team, and thus is incapable of being disbanded or unbound from the team.

The expression that a member of the first type of group is consistent with a member of the team herein may include: if being added to the first type of group, a new member may be added as a team member: if being deleted from the first type of group, a member may be deleted from the team: if being added to the team, a new member may be added to the first type of group: and if being deleted from the team, a member may be deleted from the first type of group accordingly.

Therefore, when one target group is provided, the target group is set as the first type of group managed by the team. Accordingly, the step of creating a new group to create the first type of group for the team can be omitted, and a user operation step can be reduced. Moreover, the first type of group may be created as soon as possible. Accordingly, the team notification can be transmitted as soon as possible, and an information interaction efficiency in the team can be improved.

In some embodiments, the method further includes: determining, in response to determining that at least two target groups determined are provided, a group member of a first type of group based on a group member union of the at least two target groups, and the first type of group is created.

In response to determining that at least two target groups are provided, a union may be solved from the members of the two groups (including duplicate members in these target groups) herein. Then, all or some members are selected as the group members of the first type of group based on user selection or preset exclusion rules, and the first type of group is created.

Therefore, the first type of group is automatically created for the team based on the members of the target group. Accordingly, the user is prevented from creating the first type of group, so that a user operation is reduced. In addition, the first type of group is automatically created. Compared with the condition that the first type of group is created by the user, a creation speed of the first type of group can be increased, the first type of group can be created as soon as possible, the team notification can be transmitted as soon as possible, and the information interaction efficiency in the team can be improved.

In some embodiments, after the team is created, the at least one target group is disassociated from the team created.

In some application scenarios, after the team is created, no association relation between the target group and the team created may be constructed. Therefore, the team and the target group are independent from each other, and the team is created as soon as possible through existing members of the target group only. The independence between the team and the target group can ensure that the communication of original members of the target group is not affected by the team, and various communication in the team will not affect the information interaction of the target group. Therefore, the user may perform information interaction suitable for different scenarios (for examples, in the team or in the target group).

In some embodiments, the method further includes: in response to determining that a new message is generated in one target group, displaying group conversation information of the one target group in a conversation stream of the team, and displaying the group conversation information of the one target group in the conversation stream upon selecting a conversation screening identifiers other than a team screening identifier.

The new message may be generated in the target group for various reasons herein. For example, group notifications (for example, a notification that group members quit the group, etc.) may be automatically sent in the group, the members in the target group may send new messages to a group conversation, etc. The new messages may be generated in the target group in these cases.

The conversation stream of the team is configured to collectively present the group conversation information of the group belonging to the team in the instant messaging application.

In some application scenarios, various conversation screening identifiers may be presented on a presenting interface of the instant messaging application. Conversation information corresponding to the conversation screening identifiers may be presented under different conversation screening identifiers. For example, the conversation screening identifier may include an unread message identifier, and the unread message identifier may correspond to unread conversation information. The conversation screening identifier may include the team screening identifier, and the team screening identifier may present conversation information belonging to the team group. The conversation screening identifier may include a total conversation screening identifier, and the total conversation screening identifier may present conversation information of various types of conversations in the instant messaging application.

In some scenarios, various conversations such as one-to-one conversation information and group conversation information in the instant messaging application may be presented on a total conversation stream interface. The group conversation information presented on the total conversation stream interface may be conversation information of the group associated with the team, or conversation information of the group disassociated from the team.

When the new message is generated in the target group herein, new message information of the target group is presented not only in the conversation stream of the team, but also in conversation streams corresponding to other conversation screening identifiers. Therefore, the new message information may be notified to different interface areas in the instant messaging application in time, and the user is prevented from missing the new message.

In some embodiments, determining the at least one target group in response to the preset team creation operation includes: presenting a first control on a first group interface of a first group: and determining the first group as the target group in response to an operation on the first control on the first group interface.

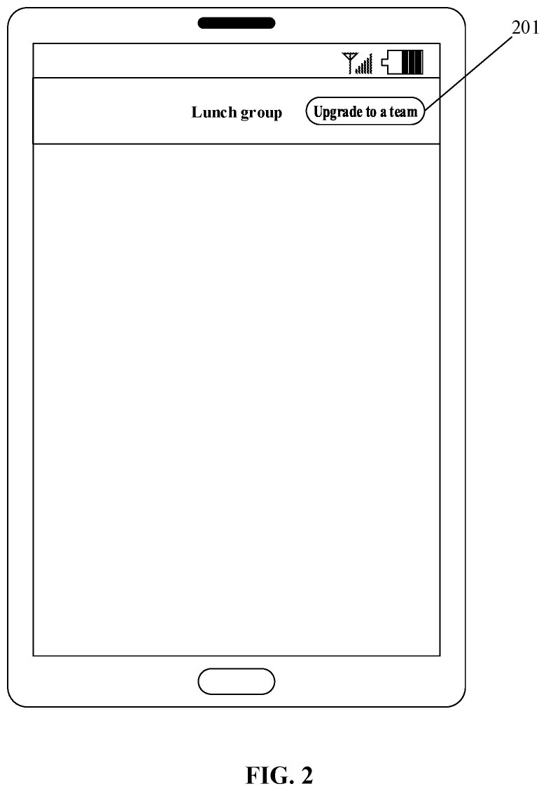

With reference to FIG. 2, an illustrative application scenario for team creation is shown in FIG. 2. Specifically, FIG. 2 is a schematic diagram of upgrading a group to a team on a first group interface. A group interface of a group named “lunch group” is presented in FIG. 2, and a first control 201 marked with the words “upgrade to a team” may be presented on the group interface.

Therefore, the user triggers the first control on the first group interface, and the first group can be rapidly determined as the target group to create the team. Accordingly, the team creation speed is increased. In addition, the first control is presented on the group interface. Accordingly, the user may be reminded that the group may be taken as the basis of the team, so that the user can use this function to rapidly create the team.

In some embodiments, determining the at least one target group in response to the preset team creation operation includes: presenting a setting interface in response to an operation on a second control: presenting at least one group identifier on the setting interface based on group permission of a user currently logged in: and determining the at least one target group based on a group identifier selection operation from the user.

The second control is configured to instruct to create a team based on the group that has been created herein.

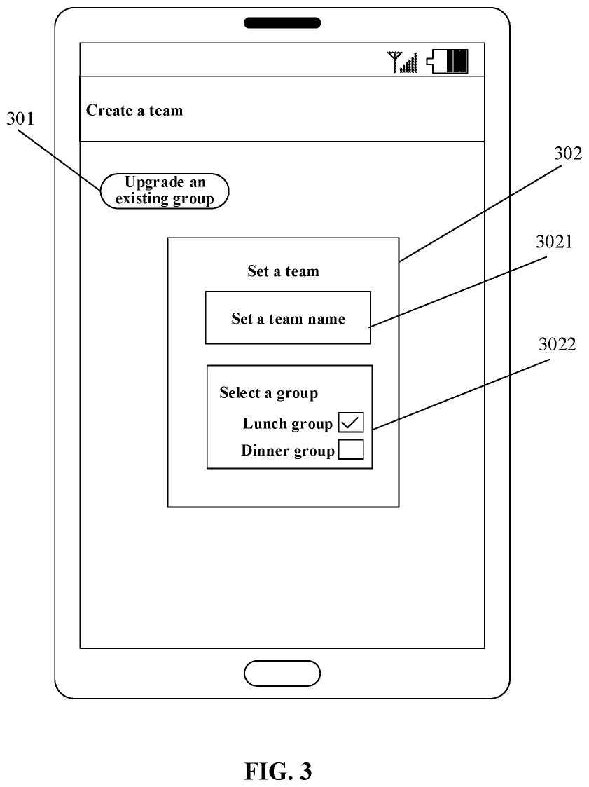

With reference to FIG. 3, another illustrative application scenario for team creation is shown in FIG. 3. A second control 301 and a setting interface 302 are shown in FIG. 3. A name control 3021 and a target group determination control 3022 may be presented on the setting interface. The name control 3021 may be configured to set a team name. The words “select a group” may be marked in the target group determination control 3022, so as to guide the user to select the target group. At least one group identifier may be presented in the target group determination control 302. For example, a group identifier named lunch group and a group identifier named dinner group may be presented. Alternatively, each group identifier may also present a selection control correspondingly. For example, the group identifier named lunch group in FIG. 3 may present the selection control correspondingly, and a check identifier in the selection control selects the group as the target group.

Therefore, the second control may guide the user to create the team based on an existing group. A group identifier of the existing group is presented for the user to select. Accordingly, the time for the user to search for a group or add people to a group one by one can be omitted, and the team creation speed can be increased. In addition, the user may select the group to form the team as demanded actually, so that the team created can satisfy actual demands.

In some embodiments, presenting the at least one group identifier on the setting interface based on the group permission of the user currently logged in includes: selecting a group for which the user currently logged in has predefined permission from groups comprising the user currently logged in as a first candidate group: and determining and presenting the at least one group identifier based on the first candidate group.

Alternatively, a group indicated by at least one group identifier determined belongs to a preset group type.

In some embodiments, selecting the group for which the user currently logged in has the predefined permission from the groups comprising the user currently logged in may include: selecting a group in which the user currently logged in is a group owner or a group administrator: or, selecting a group in which the user currently logged in is a group owner or a group administrator, and selecting a group in which the user currently logged in is not a group owner or a group administrator but has obtained consent from the group owner or the group administrator.

In some application scenarios, the group for which the user currently logged in has predefined permission may include the group in which the user currently logged in is the group owner or the group administrator.

In some application scenarios, the group for which the user currently logged in has predefined permission may include the group in which the user currently logged in is not the group owner or the group administrator but has obtained the content from the group owner or the group administrator.

As an example, the group owner or the group administrator may preset whether the group may be taken as the team creation basis by a member who is not the group owner or the group administrator. If the group owner or the group administrator presets the above inquiry to yes, the group may be taken as the group in which the user currently logged in has predefined permission without application by the user currently logged in.

As an embodiment, a preliminary identifier may be presented to the user currently logged in. If the user currently logged in selects the group in which the user currently logged in is not the group owner or the group administrator, a corresponding creation request control may be presented for the group. The user currently logged in may trigger the creation request control to apply to the group owner or the group administrator for creating a team based on the group. The group owner or the group administrator of the group may receive a creation request, and provide feedback of approval or not for the creation request.

It should be noted that the group for which the user has group owner permission or group administrator permission is selected as the team creation basis, so that no interference to the group is caused, and the impact on the use of the group caused by the abuse of team creation permission by the user currently logged in is avoided.

It should be noted that the group in which the user is not the group owner or the group administrator but has obtained content from the group owner or the group administrator is selected as the team creation basis, so that no interference to the group is caused under the condition of expanding the team creation basis. The user can take various groups (in which the user currently logged in has management permission or not) as the team creation basis conveniently by expanding the team creation basis. Compared with the condition that management permission is required to be transferred to the user currently logged in who does not have management permission at first, so as to create the team, the user operation step is omitted, and the team creation efficiency is improved.

In some embodiments, the group indicated by at least one group identifier presented belongs to a preset group type. The preset group type does not include at least one of the following: a group including an external contact, an external group, an open group, and a private chat group.

The external contact may not belong to the same organizational architecture as the user currently logged in herein.

The external group may not belong to the same organizational architecture as the user currently logged in herein.

The organizational architecture is an account system in the information interaction tool herein. The organizational architecture may also be referred to as an organizational architecture tree. The organizational architecture tree may visually denote a tree-like relation between user accounts belonging to the same organization. The user in the information interaction tool may belong to one or more organizational architectures.

The open group may be a group open to a user group in the instant messaging application herein.

The private chat group may be a group that is not presented to users other than members in the private chat group.

Therefore, when at least one group identifier is presented to the user, the group indicated by the group identifier presented may be ensured to be suitable for being upgraded to the team. Accordingly, the team information leakage caused by upgrading an unsuitable group to a team can be avoided. In addition, compared with the condition that the user selects the group suitable for being upgraded to the team, the process of automatically screening the group through a computer can ensure the result accuracy, and the user operation step and the operation time can be omitted.

In some embodiments, determining the team member set based on the members in the at least one target group includes: determining the team member set based on a member union of the at least one target group.

Herein, the union of the members of at least one target group may be determined (including removing duplicate members) at first. Then, the team member set is screened out based on user selection or preset rules.

In some embodiments, the method further includes: presenting a management control for the target group on a team management interface corresponding to the team, where the management control is configured to manage the target group.

In some application scenarios, managing the target group may be interpreted as performing management setting for the target group. Management setting for the target group may include, but is not limited to, at least one of the following: group identifier management setting, group member management setting, robot assistant management setting, message notification management setting, group display management setting, group disbandment management setting, etc.

Alternatively, management controls of some or all management setting items for the target group may be presented on the team management interface.

It should be noted that management setting is performed on the first group in an interface other than the target group interface. Compared with the condition that management setting can be performed only upon entering the target group interface, the convenience of management setting on the first group can be improved.

It should be noted that by performing management setting for the target group on the team management interface, relevant setting for the target group may be ensured to satisfy the demand of the team as much as possible. As an embodiment, a member change of the target group is managed by the team, so that the members of the target group are suitable for the team as much as possible, and team chaos generated when members who are not suitable for the team enter the target group can be avoided.

In some embodiments, the information interaction tool includes the group.

In some embodiments, the method further includes: creating the group by taking at least a part of team members in the team as group members.

After the team is created, the group may also be created based on the created team herein. It can be understood that the group created based on the team may be referred to as a team group herein. The team group may be of various types. Different communication demands in the team can be satisfied by creating different types of groups in the team.

The created group is of, but is not limited to, at least one of the following types herein: a second type of group, a third type of group, and a fourth type of group.

A team member set of the second type of group is consistent with the team member set of the team herein. The group member set of the second type of group is kept consistent with the team member set, and this group is open to the team members.

Therefore, the team members may exchange information having low confidentiality requirements in the second type of group. Moreover, different second type of groups may have different topics. In other words, the same members in different groups discuss different issues according to different topics, which can avoid the situation that information of different topics are interleaved together, resulting in information omission. Therefore, the creation of the second type of group is conducive to orderly presenting and processing of information, so that the orderliness and efficiency of information interaction in the team are improved.

A group member set of one third type of group is a proper sub-set of the team member set of the team herein, and information of the third type of group is displayed on an interaction interface of a team member not belonging to the third type of group. The members of the third type of group may be some members in the team member set. The team members that are not the members of the third type of group may see the presence of the group, but cannot obtain information in the group until the team members join the group.

Therefore, the third type of group is suitable for information interaction scenarios with moderate confidentiality requirements, giving consideration to confidentiality and openness.

A group member set of the fourth type of group is a proper sub-set of the team member set of the team, and no information of the fourth type of group is displayed on an interaction interface of a team member not belonging to the fourth type of group. Members of the fourth type of group may be some members in the team member set. The team member that are not the members of the fourth type of group cannot perceive the presence of the group.

Therefore, the fourth type of group may satisfy information interaction scenarios with high confidentiality requirements. Accordingly, information with high confidentiality requirements in the team may also be exchanged in the group without leakage, and the team information security can be improved.

In some embodiments, the method further includes: presenting a team creation success notification in response to determining that the team is created successfully: and presenting a team present interface corresponding to the team in response to a triggering operation on the team present page link.

The team creation success notification includes the team present page link herein.

When the team is created successfully, the team creation success notification is presented, and the user can be notified of the team creation condition in time herein. The team present page link is presented in the team creation success notification, the user may rapidly trigger the team present page link, and the terminal may respond to triggering of the user to rapidly present a team present page. Accordingly, the user can conveniently perform information interaction through the team present page in time, and the information interaction efficiency of the team can be improved.

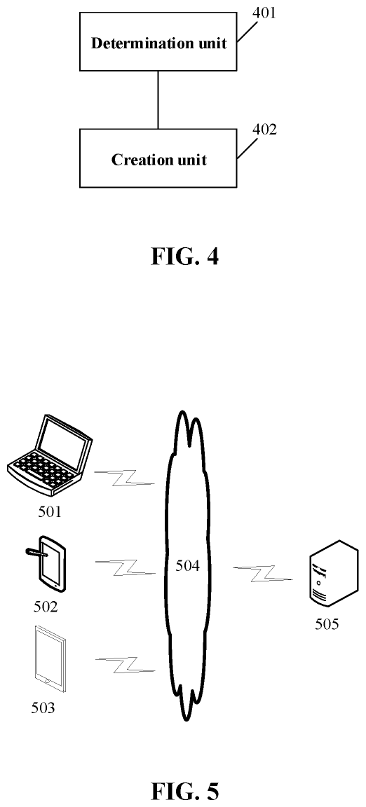

Further, with reference to FIG. 4, which serves as an implementation of the method shown in each figure above, this disclosure provides an embodiment of an information interaction apparatus. The apparatus embodiment corresponds to the method embodiment shown in FIG. 1, and the apparatus may be specifically applied to various electronic devices. As shown in FIG. 4, the information interaction apparatus in the embodiment includes: a determination unit 401 and a creation unit 402: where the determination unit is configured to determine at least one target group in response to a preset team creation operation, where the at least one target group is a group that has been created before the team creation operation: and the creation unit is configured to create a team by determining a team member set based on members included in the at least one target group, where the team is associated with at least one information interaction tool, and information in the at least one information interaction tool is acquirable by at least a part of members in the team member set.

In this embodiment, reference can be made to the related description of step 101 and step 102 in the corresponding embodiment in FIG. 1 respectively for specific processing and resulting technical effects of the determination unit 401 and the creation unit 402 of the information interaction apparatus, which will not be repeated herein.

In some embodiments, the information interaction tool includes a group: and the method further includes: the at least one target group is associated with the created team.

In some embodiments, the apparatus is further configured to determine, in response to determining that one target group determined is provided, the target group as a first type of group associated with the team: and determine, in response to determining that at least two target groups determined are provided, a group member of a first type of group based on a group member union of the at least two target groups, and create the first type of group: where a member of the first type of group is kept consistent with a member of the team; and the first type of group is incapable of being disbanded, and an association relation between the first type of group and the team is incapable of being dismissed in the presence of the team.

In some embodiments, after the team is created, the at least one target group is disassociated from the team created.

In some embodiments, the apparatus is further configured to, in response to determining that a new message is generated in one target group, display group conversation information of the one target group in a conversation stream of the team, and display the group conversation information of the one target group in the conversation stream upon selecting a conversation screening identifier other than a team screening identifier.

In some embodiments, determining the at least one target group in response to the preset team creation operation includes: presenting a first control on a first group interface of a first group: and determining the first group as the target group in response to an operation on the first control on the first group interface.

In some embodiments, determining the at least one target group in response to the preset team creation operation includes: presenting a setting interface in response to an operation on a second control, where the second control is configured to instruct to create a team based on the group that has been created: presenting at least one group identifier on the setting interface based on group permission of a user currently logged in: and determining the at least one target group based on a group identifier selection operation from the user.

In some embodiments, presenting the at least one group identifier on the setting interface based on the group permission of the user currently logged in includes: selecting a group for which the user currently logged in has predefined permission from groups comprising the user currently logged in as a first candidate group: and determining and presenting the at least one group identifier based on the first candidate group, where a group indicated by at least one group identifier determined belongs to a preset group type.

In some embodiments, selecting the group for which the user currently logged in has the predefined permission from the groups comprising the user currently logged in includes: selecting a group in which the user currently logged in is a group owner or a group administrator: or, selecting a group in which the user currently logged in is a group owner or a group administrator, and selecting a group in which the user currently logged in is not a group owner or a group administrator but has obtained consent from the group owner or the group administrator.

In some embodiments, the preset group type does not include at least one of the following: a group including an external contact, an external group, an open group, and a private chat group.

In some embodiments, determining the team member set based on the members in the at least one target group includes: determining the team member set based on a member union of the at least one target group.

In some embodiments, the apparatus is further configured to present a management control for the target group on a team management interface corresponding to the team, where the management control is configured to manage the target group.

In some embodiments, the information interaction tool includes the group: and the apparatus is further configured to create the group by taking at least a part of team members in the team as group members, where the group created includes at least one of the following: a second type of group, where a team member set of the second type of group is consistent with the team member set of the team: a third type of group, where a group member set of one third type of group is a proper sub-set of the team member set of the team, and information of the third type of group is displayed on an interaction interface of a team member not belonging to the third type of group: and a fourth type of group, where a group member set of the fourth type of group is a proper sub-set of the team member set of the team, and no information of the fourth type of group is displayed on an interaction interface of a team member not belonging to the fourth type of group.

In some embodiments, the apparatus is further configured to present a team creation success notification in response to determining that the team is created successfully, where the team creation success notification includes a team present page link: and present a team present interface corresponding to the team in response to a triggering operation on the team present page link.

With reference to FIG. 5, an illustrative system architecture to which an information interaction method in an embodiment of this disclosure can be applied is shown in FIG. 5.

As shown in FIG. 5, the system architecture may include terminal devices 501, 502, and 503, a network 504, and a server 505. The network 504 is configured to provide a communication link medium between the terminal devices 501, 502, and 503 and the server 505. The network 504 may employ various connection types, such as a wired communication link, a wireless communication link, or a fiber optic cable.

The terminal devices 501, 502, and 503 may interact with the server 505 through the network 504 to receive or send a message, etc. The terminal devices 501, 502, and 503 may be configured with various client applications, such as a web browser application, a search type application, and a news information type application. The client applications in the terminal devices 501, 502, and 503 may receive an instruction from a user and complete corresponding functions according to the instruction from the user. For example, corresponding information is added to information according to the instruction from the user.

The terminal devices 501, 502, and 503 may be hardware or software. When being the hardware, the terminal devices 501, 502, and 503, which may be various electronic devices having display screens and supporting web browsing, include, but are not limited to, a smart phone, a tablet computer, an electronic book reader, a moving picture experts group audio layer III (MP3), a moving picture experts group audio layer IV (MP4), a laptop portable computer, a desktop computer, etc. When being the software, the terminal devices 501, 502, and 503 may be mounted in the electronic devices listed above. The terminal devices may be implemented as a plurality of pieces of software or a plurality of software modules (configured to provide distributed services, for example) or as single software or single software modules, which will not be limited specifically herein.

The server 505 may be a server providing various services, for example, receiving information acquisition requests sent by the terminal devices 501, 502, and 503, acquiring display information corresponding to the information acquisition requests in various ways according to the information acquisition requests, and sending related data of the display information to the terminal devices 501, 502 and 503.

It should be noted that the information interaction method according to the embodiment of this disclosure may be executed by the terminal device, and accordingly, the information interaction apparatus may be configured in the terminal devices 501, 502, and 503. In addition, the information interaction method according to the embodiment of this disclosure may also be executed by the server 505, and accordingly, the information interaction apparatus may be configured in the server 505.

It should be understood that the numbers of the terminal devices, the network, and the server in FIG. 5 are merely illustrative. Any numbers of terminal devices, networks, and servers may be provided as required in implementation.

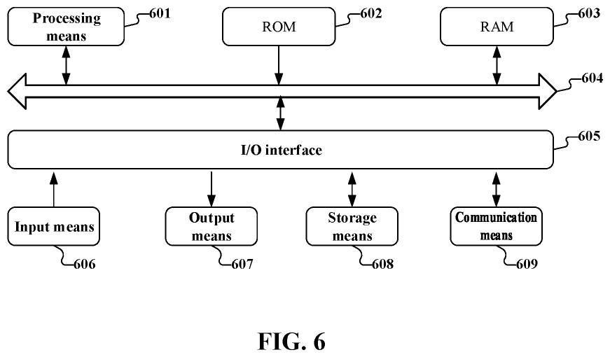

With reference to FIG. 6 below; a schematic structural diagram of an electronic device (for example, a terminal device or a server in FIG. 5) suitable for implementing an embodiment of this disclosure is shown in FIG. 6. The terminal device in the embodiment of this disclosure may include, but is not limited to, mobile terminals such as a mobile phone, a notebook computer, a digital broadcast receiver, a personal digital assistant (PDA), a pad, a portable multimedia player (PMP), an in-vehicle terminal (for example, an in-vehicle navigation terminal), and fixed terminals such as a digital television (TV) and a desktop computer. The electronic device shown in FIG. 6 is merely illustrative, and should not limit the functions and applicable scope in the embodiment of this disclosure in any way.

As shown in FIG. 6, the electronic device may include a processing means 601 (for example, a central processing unit or a graphic processor) that may execute various suitable actions and processing according to a program stored in a read-only memory (ROM) 602 or loaded into a random access memory (RAM) 603 from a storage means 608. The RAM 603 may also store various programs and data required for an operation of the electronic device 600. The processing means 601, the ROM 602, and the RAM 603 are connected to one another through a bus 604. An input/output (I/O) interface 605 is also connected to the bus 604.

Typically, the I/O interface 605 may be connected to the following apparatuses: an input means 606 such as a touch screen, a touch pad, a keyboard, a mouse, a camera, a microphone, an accelerometer, and a gyroscope: an output means 607 such as a liquid crystal display (LCD), a speaker, and a vibrator: a storage means 608 such as a magnetic tape and a hard disk: and a communication means 609. The communication means 609 may allow wireless or wired communication between the electronic device and other devices for data exchange. Although FIG. 6 shows the electronic device having various apparatuses, it should be understood that not all apparatuses shown are required to be implemented or configured. More or fewer apparatuses may be implemented or configured alternatively.

Particularly, the above processes described with reference to the flowcharts may be implemented as computer software programs according to the embodiment of this disclosure. For example, an embodiment of this disclosure includes a computer program product. The computer program product includes a computer program carried on a non-transitory computer-readable medium and encompassing program codes configured to execute the method shown in the flowchart. In such an embodiment, the computer program may be downloaded and mounted via a network through the communication means 609, mounted via the storage means 608, or mounted via the ROM 602. The computer program executes the above functions defined in the method in the embodiment of this disclosure when executed by the processing means 601.

It should be noted that the above computer-readable medium of this disclosure may be a computer-readable signal medium, a computer-readable storage medium, or any combination of the above. The computer-readable storage medium may include, but is not limited to, an electronic, magnetic, optical, electromagnetic, infrared, or semiconductor system, apparatus, or device, or any combination of the above. More specific instances of the computer-readable storage medium may include, but are not limited to, a portable computer magnetic disk, a hard disk, a random access memory (RAM), a read-only memory (ROM), an erasable programmable read-only memory (EPROM) or a flash memory, an optical fiber, a portable compact disk read-only memory (CD-ROM), an optical storage device, and a magnetic storage device that are each electrically connected through one or more wires, or any suitable combination of the above. In this disclosure, the computer-readable storage medium may be any tangible medium that encompasses or stores a program. The program may be used by or in connection with an instruction execution system, apparatus, or device. In this disclosure, however, the computer-readable signal medium may include a data signal propagating in a baseband or as part of a carrier wave, having computer-readable program codes carried thereon. Such a propagated data signal may take a variety of forms including. but not limited to, an electromagnetic signal, an optical signal, or any suitable combination of the above. The computer-readable signal medium that may also be any computer-readable medium other than the computer-readable storage medium, may send, propagate, or transmit a program to be used by or in connection with the instruction execution system, apparatus, or device. The program codes encompassed on the computer-readable medium may be transmitted via any suitable medium, including, but not limited to: a wire, an optic cable, a radio frequency (RF), etc., or any suitable combination of the above.

In some embodiments, clients and servers can communicate with each other via any currently known network protocol (such as a hypertext transfer protocol (HTTP)) or any network protocol to be developed in the future, and can be interconnected to any form or medium of digital data communication (for example, a communication network). Instances of the communication network include a local area network (LAN), a wide area network (WAN). the Internet, a peer-to-peer network (for example, an ad hoc peer-to-peer network), any currently known network, or any network to be developed in the future. 30)

The above computer-readable medium may be encompassed in the above electronic device, or exist alone without being assembled into the electronic device.

One or more programs are carried by the computer-readable medium above. When executed by the electronic device, the one or more programs above cause the electronic device to determine at least one target group in response to a preset team creation operation, where the at least one target group is a group that has been created before the team creation operation: and create a team by determining a team member set based on members included in the at least one target group, where the team is associated with at least one information interaction tool, and information in the at least one information interaction tool is acquirable by at least a part of members in the team member set.

In some embodiments, the information interaction tool includes a group: and the method further includes: the at least one target group is associated with the created team.

In some embodiments, the electronic device is further configured to determine, in response to determining that one target group determined is provided, the target group as a first type of group associated with the team: and determine, in response to determining that at least two target groups determined are provided, a group member of a first type of group based on a group member union of the at least two target groups, and create the first type of group: where a member of the first type of group is kept consistent with a member of the team: and the first type of group is incapable of being disbanded, and an association relation between the first type of group and the team is incapable of being dismissed in the presence of the team.

In some embodiments, after the team is created, the at least one target group is disassociated from the created team.

In some embodiments, the electronic device is further configured to, in response to determining that a new message is generated in one target group, display group conversation information of the one target group in a conversation stream of the team, and display the group conversation information of the one target group in the conversation stream upon selecting a conversation screening identifier other than a team screening identifier.

In some embodiments, determining the at least one target group in response to the preset team creation operation includes: presenting a first control on a first group interface of a first group: and determining the first group as the target group in response to an operation on the first control on the first group interface.

In some embodiments, determining the at least one target group in response to the preset team creation operation includes: presenting a setting interface in response to an operation on a second control, where the second control is configured to instruct to create a team based on the group that has been created: presenting at least one group identifier on the setting interface based on group permission of a user currently logged in: and determining the at least one target group based on a group identifier selection operation from the user.

In some embodiments, presenting the at least one group identifier on the setting interface based on the group permission of the user currently logged in includes: selecting a group for which the user currently logged in has predefined permission from groups comprising the user currently logged in as a first candidate group: and determining and presenting the at least one group identifier based on the first candidate group, where a group indicated by at least one group identifier determined belongs to a preset group type.

In some embodiments, selecting the group for which the user currently logged in has the predefined permission from the groups comprising the user currently logged in includes: selecting a group in which the user currently logged in is a group owner or a group administrator: or, selecting a group in which the user currently logged in is a group owner or a group administrator, and selecting a group in which the user currently logged in is not a group owner or a group administrator but has obtained consent from the group owner or the group administrator.

In some embodiments, the preset group type does not include at least one of the following: a group including an external contact, an external group, an open group, and a private chat group.

In some embodiments, determining the team member set based on the members in the at least one target group includes: determining the team member set based on a member union of the at least one target group.

In some embodiments, the electronic device is further configured to present a management control for the target group on a team management interface corresponding to the team, where the management control is configured to manage the target group.

In some embodiments, the information interaction tool includes the group: and the electronic device is further configured to create the group by taking at least a part of team members in the team as group members, where the group created includes at least one of the following: a second type of group, where a team member set of the second type of group is consistent with the team member set of the team: a third type of group, where a group member set of one third type of group is a proper sub-set of the team member set of the team, and information of the third type of group is displayed on an interaction interface of a team member not belonging to the third type of group: and a fourth type of group, where a group member set of the fourth type of group is a proper sub-set of the team member set of the team, and no information of the fourth type of group is displayed on an interaction interface of a team member not belonging to the fourth type of group.

In some embodiments, the electronic device is further configured to present a team creation success notification in response to determining that the team is created successfully, where the team creation success notification includes a team present page link: and present a team present interface corresponding to the team in response to a triggering operation on the team present page link.

The computer program codes configured to execute operations of this disclosure can be written in one or more programming languages or combinations thereof. The above programming languages include, but are not limited to, object-oriented programming languages, such as Java, Smalltalk, and C++, and conventional procedural programming languages, such as “C” language. The program codes can be executed on a user's computer in all or in part, executed as an independent software package, executed on the user's computer in part and on a remote computer in part, or executed on the remote computer or a server in all. In the case involving the remote computer, the remote computer can be connected to the user's computer through any kind of network, including the local area network (LAN) or the wide area network (WAN), or can be connected to an external computer (for example, through the Internet on the basis of an Internet service provider).

The flowcharts and block diagrams in the accompanying drawings illustrate possibly implementable system architectures, functions, and operations of the systems, methods, and computer program products according to various embodiments of this disclosure. In this regard, each block in the flowcharts or the block diagrams can represent a module, a program segment, or a code segment, which encompasses one or more executable instructions configured to implement specified logical functions. It should also be noted that in some alternative embodiments, the functions noted in the blocks can also occur in an order other than those noted in the accompanying drawings. For example, two blocks represented in succession can in fact be executed substantially in parallel or in a reverse order sometimes, depending on the functions involved. It should also be noted that each block in the block diagrams and/or the flowcharts and combinations of blocks in the block diagrams and/or the flowcharts can be implemented through special-purpose hardware-based systems that execute the specified functions or operations, or can be implemented through combinations of special-purpose hardware and computer instructions.

The unit described in the embodiment of this disclosure can be implemented through software or hardware. The name of the unit is not intended to define the unit under some circumstances. For example, the determination unit may also be described as “the unit configured to determine at least one target group”.

The above functions herein can be executed, at least in part, by one or more hardware logical components. For example, non-restrictively, illustrative types of usable hardware logical components include: a field programmable gate array (FPGA), an application specific integrated circuit (ASIC), an application specific standard product (ASSP), a system on chip (SOC), a complex programmable logic device (CPLD), etc.

In the context of this disclosure, a machine-readable medium can be a tangible medium that can encompass or store a program to be used by or in combination with the instruction execution system, apparatus, or device. The machine-readable medium can be a machine-readable signal medium or a machine-readable storage medium. The machine-readable medium can include, but is not limited to, an electronic, magnetic, optical, electromagnetic, infrared, or semiconductor system, apparatus, or device, or any suitable combination of the above. More specific instances of the machine-readable storage media include a portable computer disk, a hard disk, a random access memory (RAM), a read-only memory (ROM), an erasable programmable read-only memory (EPROM) or a flash memory. an optical fiber, a portable compact disk read-only memory (CD-ROM), an optical storage device, and a magnetic storage device that are each electrically connected through one or more wires, or any suitable combination of the above.

What are described above are merely the preferred embodiments of this disclosure and the descriptions of the technical principles applied. It should be understood by those skilled in the art that the scope of disclosure involved in this disclosure is not limited to the technical solutions formed by specific combinations of the above technical features, and should also cover other technical solutions formed by random combinations of the above technical features or their equivalents without departing from the concept disclosed above. For example, the technical solutions formed through mutual replacement between the above features and the technical features having similar functions disclosed in this disclosure (but not limited thereto).

In addition, all the operations are depicted in a specific order. However, it should not be understood that these operations are required to be executed in the specific order shown or in a successive order. Under certain circumstances, multitasking and parallel processing may be advantageous. Similarly, several specific embodiment details are encompassed in the above discussion, but should not be interpreted as limiting the scope of this disclosure. Some features that are described in the context of separate embodiments can also be implemented jointly in a single embodiment. Likewise, various features that are described in the context of a single embodiment can also be implemented in a plurality of embodiments separately or in any suitable sub-combination manner.

Although the subject has been described in language specific to structural features and/or logical method actions, it should be understood that the subject defined in the appended claims is not necessarily limited to the above specific features or actions. Rather, the above specific features and actions are merely illustrative forms for implementing the claims.

1. An information interaction method, comprising:
determining at least one target group in response to a preset team creation operation, wherein the at least one target group is a group that has been created before the team creation operation; and
creating a team by determining a team member set based on members comprised in the at least one target group, wherein the team is associated with at least one information interaction tool, and information in the at least one information interaction tool is acquirable by at least a part of members in the team member set.

2. The method according to claim 1, wherein
the information interaction tool comprises a group; and
the method further comprises: associating the at least one target group with the created team.

3. The method according to claim 2, further comprising:
determining, in response to determining that one target group determined is provided, the target group as a first type of group associated with the team; and
determining, in response to determining that at least two target groups determined are provided, a group member of a first type of group based on a group member union of the at least two target groups, and creating the first type of group;
wherein a member of the first type of group is kept consistent with a member of the team.

4. The method according to claim 3, wherein
the first type of group is incapable of being disbanded, and an association relation between the first type of group and the team is incapable of being dismissed in the presence of the team.

5. The method according to claim 1, wherein
the at least one target group is disassociated from the created team after the team is created.

6. The method according to claim 2, further comprising:
in response to determining that a new message is generated in one target group, displaying group conversation information of the one target group in a conversation stream of the team, and displaying the group conversation information of the one target group in the conversation stream upon selecting a conversation screening identifier other than a team screening identifier.

7. The method according to claim 1, wherein determining the at least one target group in response to the preset team creation operation comprises:
presenting a first control on a first group interface of a first group; and
determining the first group as the target group in response to an operation on the first control on the first group interface.

8. The method according to claim 1, wherein determining the at least one target group in response to the preset team creation operation comprises:
presenting a setting interface in response to an operation on a second control, wherein the second control is configured to instruct to create a team based on the group that has been created;
presenting at least one group identifier on the setting interface based on group permission of a user currently logged in; and
determining the at least one target group based on a group identifier selection operation from the user.

9. The method according to claim 8, wherein presenting the at least one group identifier on the setting interface based on the group permission of the user currently logged in comprises:
selecting a group for which the user currently logged in has predefined permission from groups comprising the user currently logged in as a first candidate group; and
determining and presenting the at least one group identifier based on the first candidate group.

10. The method according to claim 9, wherein selecting the group for which the user currently logged in has the predefined permission from the groups comprising the user currently logged in comprises:
selecting a group in which the user currently logged in is a group owner or a group administrator; or
selecting a group in which the user currently logged in is a group owner or a group administrator, and selecting a group in which the user currently logged in is not a group owner or a group administrator but has obtained consent from the group owner or the group administrator.

11. The method according to claim 8, wherein a group indicated by the at least one group identifier presented belongs to a preset group type; wherein
the preset group type does not comprise at least one of the following: a group comprising an external contact, an external group, an open group, and a private chat group.

12. The method according to claim 1, wherein determining the team member set based on the members in the at least one target group comprises:
determining the team member set based on a member union of the at least one target group.

13. The method according to claim 2, further comprising:
presenting a management control for the target group on a team management interface corresponding to the team, wherein the management control is configured to manage the target group.

14. The method according to claim 1, wherein the information interaction tool comprises the group; and
the method further comprises:
creating the group by taking at least a part of team members in the team as group members, wherein the group created comprises at least one of the following:
a second type of group, wherein a group member set of the second type of group is consistent with the team member set of the team;
a third type of group, wherein a group member set of one third type of group is a proper sub-set of the team member set of the team, and information of the third type of group is displayed on an interaction interface of a team member not belonging to the third type of group; and
a fourth type of group, wherein a group member set of one fourth type of group is a proper sub-set of the team member set of the team, and no information of the fourth type of group is displayed on an interaction interface of a team member not belonging to the fourth type of group.

15. The method according to claim 1, further comprising:
presenting a team creation success notification in response to determining that the team is created successfully, wherein the team creation success notification comprises a team present page link; and
presenting a team present interface corresponding to the team in response to a triggering operation on the team present page link.

16. (canceled)

17. An electronic device, comprising:
one or more processors; and
a storage means configured to store one or more programs;
the one or more programs, when executed by the one or more processors, causing the one or more processors to;
determine at least one target group in response to a preset team creation operation, wherein the at least one target group is a group that has been created before the team creation operation; and
create a team by determining a team member set based on members comprised in the at least one target group, wherein the team is associated with at least one information interaction tool, and information in the at least one information interaction tool is acquirable by at least a part of members in the team member set.

18. A non-transitory computer-readable medium, storing a computer program thereon, wherein the computer program, when executed by a processor, implements;
determining at least one target group in response to a preset team creation operation, wherein the at least one target group is a group that has been created before the team creation operation; and
creating a team by determining a team member set based on members comprised in the at least one target group, wherein the team is associated with at least one information interaction tool, and information in the at least one information interaction tool is acquirable by at least a part of members in the team member set.

19. The non-transitory computer-readable medium according to claim 17, wherein
the information interaction tool comprises a group; and
the one or more processors are further caused to: associate the at least one target group with the created team.

20. The non-transitory computer-readable medium according to claim 19, wherein the one or more processors are further caused to:
determine, in response to determining that one target group determined is provided, the target group as a first type of group associated with the team; and
determine, in response to determining that at least two target groups determined are provided, a group member of a first type of group based on a group member union of the at least two target groups, and create the first type of group;
wherein a member of the first type of group is kept consistent with a member of the team.

21. The electronic device according to claim 20, wherein
the first type of group is incapable of being disbanded, and an association relation between the first type of group and the team is incapable of being dismissed in the presence of the team.
